(19) United States
(12) Patent Application Publication
(10) Pub. No.: US 2013/0039722 A1
(43) Pub. Date: Feb. 14, 2013

(54) METAL STRIPS WITH METALLIC-APPEARANCE EXCELLENT IN FORMING STABILITY AND SEAMLESSLY-FORMED CAN BODY AND MANUFACTURING METHOD THEREOF

(71) Applicant: NIPPON STEEL CORPORATION, TOKYO (JP)

(72) Inventors: TORU CHICHIKI, KITAKYUSHU-SHI (JP); MASAYOSHI SUEHIRO, FUTTSU-SHI (JP); HIROSHI NISHIDA, KITAKYUSHU-SHI (JP); OSAMU MIYAMAE, KITAKYUSHU-SHI (JP); HIROKAZU YOKOYA, KITAKYUSHU-SHI (JP); TAKAHARU KATAOKA, KITAKYUSHU-SHI (JP)

(73) Assignee: NIPPON STEEL CORPORATION, TOKYO (JP)

(21) Appl. No.: 13/652,062

(22) Filed: Oct. 15, 2012

(30) Foreign Application Priority Data
Feb. 13, 2003 (JP) 2003035588

(51) Int. Cl. B21D 51/26; B05D 1/28

(52) U.S. Cl. 413/1; 427/428.01

(57) ABSTRACT

A metal band having metallic appearance and being excellent in forming stability is provided. The metal band includes a coating film containing not less than 20 mass % in the coated and dried state, of filler of aluminum or aluminum alloys on the side thereof corresponding to the outside of a can. The metal band also has a resin-rich portion containing not more than approximately 5 mass % of the filler, approximately 0.1 to 20 μm in thickness in the coated surface far from the metal strip surface, seamlessly-formed can bodies made of such strips. Methods for manufacturing such strips and can bodies are also provided.

### TECHNICAL FIELD

The present invention relates to metal strips permitting stable ironing, cans bodies made of such metal strips, and method for manufacturing such metal strips and cans.

### BACKGROUND ART

Drawn and ironed cans have conventionally been used widely for beverage containers because of the ease of low-cost mass production. Drawn and ironed cans are generally manufactured, in order to insure good ironing, by ironing tinplates and aluminum sheets while applying lubricants on the surface thereof.

In order to prevent rusting on the external surface and secure corrosion resistance on the internal surface, however, this method must apply a coating on the surfaces. Therefore, it has involved a problem that each can must pass a low-productivity step to remove the lubricant with alkali or other detergent after ironing and, then, apply a coating after the chemical treatment.

As a technique to improve productivity by eliminating the low-productivity step required for each can, it has been proposed to pre-apply a resin film lamination or resin-coating on both surfaces of metal strips.

When metal strips are laminated with resin film, it is necessary to secure a film strength which will withstand ironing and permit mass production. This necessitates the use of at least 10 μm or thicker films, which, in turn, which unavoidably results in a cost increase.

When coating resin paint on metal strips, it is relatively easy to reduce the thickness of coated film. Not having as high a degree of polymerization as a film resin, however, coated film has low resistance to ironing and, therefore, does not provide adequate forming stability at high speed.

Methods to apply a paint containing aluminum filler on one side of steel sheet and a paint containing lubricant on the other have been proposed as a technique to improve ironing formability. For example, Japanese Unexamined Patent Publication No. 02-303633 discloses a technique of forming a coated film containing aluminum filler on the inside of cans.

On the outside of cans, however, the force to change a form associated with a thickness reduction during ironing is much greater than on the inside. As a result, aluminum filler is sometimes exposed to the surface layer of a coated film where heavy ironing is applied. The exposed aluminum filler at the surface layer of coated film sometimes adheres to ironing dies, induces troubles and makes continuous volume production difficult.

Many studies have been made on optimum conditions for metal dies used in the ironing of metal strips applied with common resin paints and those coated with resin films in the dry state.

Japanese Unexamined Patent Publications Nos. 09-285826, 09-285827 and 09-285828 disclose'techniques for achieving stability in ironing by specifying the entry and exit half angles of dies and the radius of curvature of the bearing portion between the entry and exit half angles. However, no study has been done on optimum conditions for metal dies used in the ironing of metal strips coated with metallic-appearance coatings containing aluminum fillers.

As such, it has been desired that a study be done on the optimum profile of metal dies for the ironing of steel sheets coated with metallic-appearance coated films.

While roll-coating methods to apply common resin paints on the external surface of steel sheets have been established, no study has yet been done on coating conditions for controlling the distribution of filler in the direction of thickness coating in one roll coating.

### SUMMARY OF THE INVENTION

The present invention avoids the defects in said prior arts and provides metal strips having greater forming stability for forming seamless cans having a coated film containing metal fillers on the external surface thereof by ironing, cans made of said metal strips, and methods for manufacturing said metal strips and cans.

In order to solve said conventional problems, the present invention provides one-side coated metal strips having dramatically increased stability in ironing obtainable by adding aluminum filler at an appropriately controlled thickness to the paint to be coated on the outside of cans and strictly controlling the individual ironing steps and the quality of base material and seamlessly formed cans made thereof and method for manufacturing said metal strips and cans.

The gist of the present invention is as given below:

(1) A metal strip with metallic-appearance excellent in forming stability, having a only one coated film layer on the side thereof corresponding to the outside of a can, characterized by;

comprising a filler-rich portion containing not less than 20 mass, in the coated and dried state, of a filler of aluminum or aluminum alloys,

and a resin-rich portion containing not more than 5 mass % of said filler 0.1 to 20 μm in thickness upon the filler-rich portion,

wherein the filler is dilutely distributed in the direction of the coated layer thickness.

(2) A metal strip with metallic-appearance excellent in forming stability, having a only one coated film layer on the side thereof corresponding to the external side of a can, characterized by;

comprising a filler-rich portion containing not less than 20 mass, in the coated and dried state, of a filler of aluminum or aluminum alloys,

and a resin-rich portion containing not more than 5 mass % of said filler 0.3 to 10 μm in thickness upon the filler-rich portion,

wherein the filler is dilutely distributed in the direction of the coated layer thickness.

(3) A metal strip with metallic-appearance excellent in forming stability described in (1) or (2) above, wherein a resin film not less than 8 μm thick is laminated on the side thereof corresponding to the internal side of said can.

(4) A metal strip with metallic-appearance excellent in forming stability described in any of (1) to (3) above, wherein a polyester or polyolefin resin film is laminated on the side thereof corresponding to the internal side of said can.

(5) A metal strip with metallic-appearance excellent in forming stability described in any of (1) to (4) above, wherein the coated film on the external side of said can contains one or more of polyester, epoxyphenol and vinyl organosol.

(6) A method for manufacturing metal strip with metallic-appearance excellent in forming stability, characterized by;

setting the ratio a/(a+b) at 20 to 45%, where a is the sum of the weights of the filler of aluminum or aluminum alloys and resin in the paint and (a+b) is the sum of said sum a and the mass b of organic solvent for dissolving the paint, and

roll-coating or photogravure-coating at the linear pressure of not less than 3 kg/cm between the metal strip and rolls by using coating-rolls having a diameter of not more than 500 mmφ.

(7) A method for manufacturing metal strip with metallic-appearance excellent in forming stability described in (6) above, wherein the statistic viscosity of the paint applied by roll-coating is 20 to 350 centipoise at 20° C.

(8) A seamlessly-formed can body, characterized by;

comprising a filler-rich portion containing not less than 5 mass %, in the coated and dried state, of a filler of aluminum or aluminum alloys on the side thereof corresponding to the outside of a can,

and a resin-rich portion containing not more than 5 mass % of said filler 0.03 μm in thickness upon the filler-rich portion,

wherein the filler is dilutely distributed in the direction of the coated layer thickness.

(9) A seamlessly-formed can body, characterized by;

comprising a filler-rich portion containing not less than 20 mass %, in the coated and dried state, of a filler of aluminum or aluminum alloys on the side thereof corresponding to the outside of a can,

and a resin-rich portion containing not more than 5 mass % of said filler 0.03 μm in thickness upon the filler-rich portion,

wherein the filler is dilutely distributed in the direction of the coated layer thickness.

(10) A seamlessly-formed can body described in (8) or (9) above, wherein the body has a laminated resin film.

(11) A seamlessly-formed can body described in any of (8) to (10) above, wherein the body has a resin film of one or more of polyester, epoxyphenol and vinyl organosol.

(12) A method for manufacturing seamlessly-formed can body, characterized by;

applying multistage ironing to the metal strip described in any of (1) to (5) above with a thickness reduction ratio γ by using two or more dies:

Total thickness reduction ratio γ<58+11d^{0.35} (d: thickness (μm) of the resin-rich portion containing not more than 5 mass % of filler in the coated surface far from the coated side).

(13) A method for manufacturing seamlessly-formed can body described in (12) above, wherein ironing is performed by using a die whose intersection point between the entry and exit half angles has a radius of curvature not less than 0.02 mmφ, with the entry half angle set at 2 to 10°.

(14) A method for manufacturing seamlessly-formed can body described in (12) above, wherein ironing is performed by using a die whose intersection point between the entry and exit half angles has a radius of curvature not less than 0.01 mmφ, with the entry half angle set at 2 to 18°.

### BRIEF DESCRIPTION OF THE DRAWINGS

FIG. 1 shows the cross-sectional surface structure a metal strip according to the present invention.

FIG. 2 shows a coating process to apply resin on a metal strip according to the present invention.

FIG. 3 shows the cross-section of a metal die used in the ironing of a metal strip according to the present invention.

### THE MOST PREFERRED EMBODIMENT

Details of the invention are described below with reference to the attached drawings.

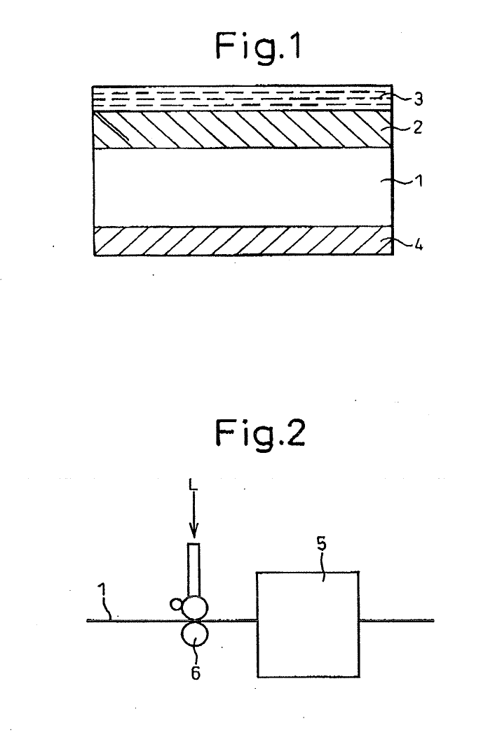

First, the metal strips of the present invention will be explained. FIG. 1 shows the cross-sectional surface structure of a metal strip according to the present invention. As is illustrated, a coated film 2 containing a filler of aluminum or aluminum alloys is formed on the surface of a metal strip 1, with a filler-free layer (a resin-rich portion) 3 formed on top thereof and a coated film or resin film 4 is formed on the other side.

Although the thickness of the metal strip need not be specified, 0.15 to 0.35 mm thick steel sheets suited for can making are commonly used.

So long as adhesiveness to resin and ironing formability are secured, surface properties of the metal strip need not be specified. In order to secure adhesiveness, however, it is desired to apply surface pretreatment with chromic acid, dichromic acid, phosphoric acid, organic acids, etc.

The metal strips of the present invention may be of aluminum, aluminum alloys, tin-free steel, chromium-coated steel, nickel-coated steel, phosphated steel, phosphated resin-coated steel, tin-coated steel, tin-nickel coated steel, etc.

Before ironing, a coated film (hereinafter sometimes referred to as the “filler-containing coated film) containing not less than 5 mass %, preferably not less than 20 mass, of filler of aluminum or aluminum alloys is formed on the side corresponding to the external side of cans. If the content of the filler is less than 5 mass %, the filler-containing coated film does not provide sufficient coating on the surface subjected to ironing. Then, resistance to ironing becomes uneven, which, in turn, damages the coated film by galling or other problem.

Fillers consisting of aluminum or aluminum alloys are used because aluminum or aluminum alloys excel in drawability, which facilitates deformation and elongation during ironing and avoids the concentration of ironing stress to certain specific parts on the external side.

Purity enhancement, alloying, crystalline structure control and annealing further increase the formability of aluminum. Therefore, resistance to ironing can be decreased by applying said treatments. This effect is prominent when the filler content is not less than 20 mass.

The resins used for the purpose of the present invention are not particularly limited to any specific ones so long as surface hardness is high enough to withstand ironing. It is preferable to use any of polyester, epoxyphenol and vinyl organosol that have good formability.

The surface hardness of resins is preferably not more than 2H in terms of pencil hardness rating. The color of resins can be changed by adding chemical pigments and dyes other than aluminum pigments.

In the structure of resin film, the distribution of filler is controlled so that the portion containing not more than 5 mass % of filler formed in the coated film far from the metal strip surface (hereinafter referred to as the filler-free portion) is 0.1 to 20 μm, preferably 0.3 to 10 μm, in thickness before ironing. While the thickness of the filler-free portion (resin-rich portion) before ironing is not less than 0.1 μm, the thickness of the filler-free portion in the can body portion after ironing is not less than 0.03 μm.

The content of aluminum filler in the coated film is determined based on the mass ratio derived by measuring the areas of the aluminum filler and resin in electron photomicrographs of magnification not less than 2000 of not fewer than 50 specimens taken at random, with specific gravity correction.

If the thickness of the filler-free portion before ironing is less than 0.1 μm, the surface deforming force resulting from thickness change induced by ironing prompts the exposure of filler to the formed surface and makes difficult the execution of stable high-speed ironing.

If the thickness of the filler-free portion before ironing exceeds 10 μm, propagation of ironing force to the metal surface becomes uneven and induces surface galling.

In order to realize stable high-speed ironing, the pre-ironing thickness of the filler-free portion is preferably not less than 0.3 μm and more preferably 1 to 8 μm.

As the present invention does not require any particular adhesiveness between the filler and metal strip, the density distribution of filler in the coated film is not particularly specified. However, highly adhesive primary resin to increase the adhesiveness between the filler and metal strip may be applied before the pigment containing aluminum filler is applied.

The coating on the side of metal strips corresponding to the internal side of cans is not particularly limited so long as it withstands ironing and provides enough corrosion resistance required of the formed inside. Commonly, pigments containing any of polyester, epoxyphenol and vinyl organosol are applied to a thickness of not less than 1 μm or resin film is laminated.

Any kind of metal strips can be used so long as adequate formability to withstand ironing is obtainable. If the coated side is the side corresponding to the internal side of cans, it is preferable that material hardness is under 57 in terms of HR30T.

If material hardness is greater than 57 in terms of HR30T, resistance to ironing increases, which, in turn, induces an increase in surface ironing force and makes it difficult to secure adequate coating adhesiveness on both sides of cans.

The use of any of polyester, epoxyphenol and vinyl organosol for the coating film on the external side further stabilizes ironing formability.

Compared with the coating on the side of metal strips corresponding to the internal side of cans, laminating not less than 8 μm resin film on that side provides greater ironing force. This permits using harder metal strips and, as a consequence, facilitates weight reduction of cans through reduction of metal strip thickness.

Metal strips whose hardness is up to 73 in terms of HR30T can be used. Preferable resin films are of polyester or polyolefin having high enough formability to withstand ironing.

If film thickness is less than 8 μm, resistance to surface galling decreases to such an extent as to destabilize the ironing of hard metals.

The use of any of polyester, epoxyphenol and vinyl organosol for the coating on the external side of metal strips further stabilizes ironing formability.

Next, details of coating method to secure adequate coating thickness in the filler-free portion is described at length. FIG. 2 shows a coating process to apply resin on a metal strip. As is illustrated, a film of resin is formed on a metal strip 1 by applying a pressure L on coating rolls 6 and the film is then dried in a drying oven 5.

In this coating, the ratio of the solid content to the total sum of the solid content of organic solvent is 20 to 45 mass %. Though the solvent need not be particularly limited, mixed solvents of toluene, benzene, ether, etc. are commonly used.

If the ratio of the solid content to the total, sum of the solid content of organic solvent exceeds 45 mass %, viscosity increases and high-speed coating becomes difficult. If the ratio is less than 20 mass %, the position of the filler is destabilized in the drying process, which makes the formation of the filler-free portion difficult and facilitates the dissipation of the filler throughout the entire thickness of the coating.

In order to gather the filler as close as possible to the surface of the metal strip in coating and realize the desired filler distribution in the coated film, it is necessary to adjust the pressure applied to the strip by the coating rolls.

The pressure on the strip is governed by the diameter and linear pressure of the rolls. Here, the roll linear pressure was evaluated from L/W, wherein L is the axial load determined by a load cell disposed in the roll bearing and W is the width of the metal strip to be coated.

The coated film according to the present invention is formed with the use of rolls whose diameter is not more than 500 mmφ and linear pressure not less than 3 kg/cm. While the roll linear pressure can be secured by several methods such as the use of backup rolls in coating, the present invention imposes no particular limitation.

If the roll linear pressure is less than 3 kg/cm, the force to keep the filler in close contact with the surface of the metal strip, which, in turn, impairs parallelism of the filler in the coated film with respect to the surface of the metal strip and facilitates the dissipation of the filler in the direction of the thickness of the coated film. As a consequence, it becomes difficult to secure the thickness of the filler-free portion.

The viscosity (static viscosity) of the paint applied is preferably 20 to 350 centipoise at 20° C. If the viscosity is less than 20 centipoise, the aluminum filler disperses just after coating, which, in turn, tends to result in poor appearance. If the viscosity exceeds 350 centipoise, adhesion between the filler and base metal decreases.

The above description is based on a method that forms the filler-free portion in one roll coating. In order to insure the formation of the filler-free portion, a resin-rich layer containing not more than 5% aluminum filler may be added after a coated film containing not less than 5% aluminum filler has been formed.

Next, methods to form the metal strips according to the present invention are described.

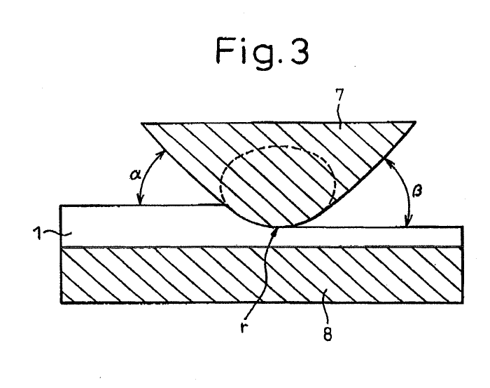

FIG. 3 shows the cross section of a metal die used for ironing the metal strip according to the present invention. FIG. 3 shows a metal strip 1 formed by an upper die 7 that comes in contact with the external side of a can and a lower die 8.

In order to achieve stable ironing of the coated metal strip 1, it is necessary to control the surface forming force within the limit of the tensile shear strengths of the resin at the forming temperature.

While the strength of the coated film generally varies with the composition and crystalline condition thereof and the temperature, the coated film is hardened by the forming heat. Thus, the inventors took note of the fact that the heat generation due to ironing influences the limit of the total thickness reduction ratio that indicates the possibility of ironing and investigated the relationship between the heat value or the total thickness reduction ratio in ironing and the condition of the coated film.

The investigation led to the finding that, for the prevention of occurrence of coating film damage during ironing, the thickness and total thickness reduction ratio of the aluminum filler layer must satisfy the relationship expressed by the following equation:

Total thickness reduction ratio γ<58+11d^{0.35}

wherein total thickness reduction ratio γ(%) is the reduction in thickness between before and after forming divided by the original strip thickness, and

d is the thickness (μm) of the resin-rich (thickness of the filler-free layer) portion containing not more than 5 mass % of filler in the coated surface far from the coated side.

When iron is applied to the coated surface, the total thickness reduction ratio γ that permits ironing depends greatly on the thickness d of the filler-free layer at the surface.

If the thickness d of the filler-free layer is small and severe ironing beyond said total thickness reduction ratio is applied, the resin at the surface can no longer adequately cover the filler, as a result of which the filler becomes exposed to the uppermost layer of the can, builds up on the surface of the metal dies, and increases the heat volume generated thereby. This, as a result, impairs the efficiency of the ironing work.

In the forming of seamless cans, securing of can height and reduction of wall thickness are commonly achieved by combining drawing, ironing and stretching. If work design is made to keep the total thickness reduction ratio in ironing within the limit defined by the equation given earlier, cans having the desired height can be stably manufactured in large volume without damaging the coated film and causing metal die trouble.

In order to achieve stable ironing by forming a coated film containing a controlled smaller amount of aluminum or aluminum filler on the outermost side of said can, it is necessary, unlike in the ironing of conventional coated metal strips, to avoid, as much as possible, a stress concentration between the coated film and aluminum filler that is induced by the ironing stress on the resin at the surface of the coated film.

For this purpose, it is necessary to minimize the entry half angle (see α in FIG. 3) and inhibit the swelling of the coated film in the vicinity of the metal dies during ironing.

Study of appropriate conditions for the minimization and inhibition led to a finding that if the entry half angle exceeds 18° the swelling of the coated film just before ironing can not be sufficiently inhibited and, as a consequence, galling oz exposure of the aluminum filler becomes likely to occur.

If the entry half angle is smaller than 2°, the contact area between the dies and coated film becomes unstable and resistance to ironing tends to vary. This leads to the creation of uneven ironing and other appearance defects at the surface of the formed surface.

Though the present invention does not particularly limit exit half angle (see β in FIG. 3), it is preferable, for the assurance of stable surface gloss, to keep the exit half angle between 1° and 25°. If the radius of curvature of the curved surface at the point of intersection between the entry and exit half angles (see γ in FIG. 3) is smaller than 0.1 mmφ, surface contact becomes so great that the appearance of the can surface tends to become impaired as a result of heat generation. If the entry half angle is smaller than 10°, the curvature can be reduced to 0.02 mmφ.

Though the ironing work according to the present invention is based on dry ironing without lubricant, ironing with solid lubricant, such as Vaseline, or wet ironing with lubricant is also applicable.

Examples of the present invention are concretely described below.

### Example 1

Tin-free steel sheets, 0.22 mm thick, bright finished, temper T·3 and total chromium amount 80 mg/m², with the external and internal surfaces coated under the conditions shown in Table 1 were subjected to ironing under the conditions shown in Table 1. Table 1 also shows the appearance of the cans thus obtained. The steel sheets according to the present invention also had good appearance.

As to the appearance of cans, the degree of glossiness was measured twice at randomly selected 10 points. The cans whose difference between the maximum and minimum measurements falls within ±10% of the overall average were classed as ⊚ (best) and those whose difference between the maximum and minimum measurements exceeds ±10% and falls within ±15% as ∘ (practically usable).

The degree of glossiness was determined by measuring the light reflected at an angle of 60° with respect to the direction in which coating is done on the metal strip.

TABLE 1

| | External Side | | | | | | | | |
|---|---|---|---|---|---|---|---|---|---|
| | | | Dry | Filler- | | | | Coating Conditions | |
| | | | Weight | free | Internal Side | | | Roll | Linear |
| | | | Ratio | Layer | | | Thickness | Diameter | Pressure |
| | Pigment | Resin | (%) | (μm) | Condition | Resin | (μm) | (nm) | (kg/cm) |
| 1 | Aluminum | Polyester | 20 | 3 | Laminated | PET | 25 | 300 | 3 |
| 2 | | | 30 | 3 | Laminated | PET | 25 | 300 | 3 |
| 3 | | | 40 | 3 | Laminated | PET | 25 | 300 | 3 |
| 4 | | | 50 | 3 | Laminated | PET | 25 | 300 | 3 |
| 5 | | | 50 | 1 | Laminated | PET | 25 | 300 | 3 |
| 6 | | | 50 | 3 | Laminated | PET | 25 | 300 | 3 |
| 7 | | | 50 | 5 | Laminated | PET | 25 | 300 | 3 |
| 8 | | | 50 | 10 | Laminated | PET | 25 | 300 | 3 |
| 9 | | Epoxyphenol | 30 | 3 | Laminated | PET | 25 | 300 | 3 |
| 10 | | vinyl | 30 | 3 | Laminated | PET | 25 | 300 | 3 |
| | | organosol | | | | | | | |
| 11 | | Polyester | 50 | 3 | Coated | Epoxyphenol | 6 | 300 | 3 |
| 12 | | | 50 | 3 | Coated | Vinyl | 6 | 300 | 3 |
| | | | | | | organosol | | | |
| 13 | | | 20 | 0.05 | Laminated | PET | 25 | 300 | 2 |
| 14 | | | 30 | 0.05 | Laminated | PET | 25 | 300 | 2 |
| 15 | | | 40 | 0.05 | Laminated | PET | 25 | 300 | 2 |
| 16 | | | 50 | 0.05 | Laminated | PET | 25 | 300 | 2 |
| 17 | | | 50 | 0.05 | Laminated | PET | 25 | 300 | 3 |
| 18 | | | 50 | 0.05 | Laminated | PET | 25 | 300 | 3 |
| 19 | | | 50 | 0.05 | Laminated | PET | 25 | 300 | 3 |
| 20 | | | 50 | 22 | Laminated | PET | 25 | 300 | 3 |
| 21 | | | 30 | 0.05 | Laminated | PET | 25 | 300 | 3 |
| 22 | | | 50 | 0.05 | Coated | Epoxyphenol | 6 | 300 | 3 |
| 23 | | | 50 | 0.05 | Coated | Epoxyphenol | 6 | 300 | 3 |

| | Ironing | | | | | | |
|---|---|---|---|---|---|---|---|
| | | | Metal Dies | | | | |
| | Total | | Entry | Exit | | | |
| | Ironing | 58 + | Half | Half | Radius of | Appearance | |
| | Ratio | lid [symbol] | Angle | Angle | Curvature | of Can | Remarks |
| 1 | 70 | 74.2 | 10 | 10 | 0.2 | ◯ | Examples |
| 2 | 70 | 74.2 | 10 | 10 | 0.2 | ◯ | of the |
| 3 | 70 | 74.2 | 10 | 10 | 0.2 | ◯ | present |
| 4 | 70 | 74.2 | 10 | 10 | 0.2 | ◯ | invention |
| 5 | 65 | 69.0 | 10 | 10 | 0.2 | ◯ | |
| 6 | 70 | 74.2 | 10 | 10 | 0.2 | ◯ | |
| 7 | 75 | 77.3 | 10 | 10 | 0.2 | ◯ | |
| 8 | 78 | 82.6 | 10 | 10 | 0.2 | ◯ | |
| 9 | 70 | 74.2 | 10 | 10 | 0.2 | ◯ | |
| 10 | 72 | 74.2 | 10 | 10 | 0.2 | ◯ | |
| 11 | 72 | 74.2 | 10 | 10 | 0.2 | ◯ | |
| 12 | 72 | 74.2 | 10 | 10 | 0.2 | ◯ | |
| 13 | 70 | 61.9 | 10 | 10 | 0.2 | Galling | Examples |
| 14 | 70 | 61.9 | 10 | 10 | 0.2 | | for |
| 15 | 70 | 61.9 | 10 | 10 | 0.2 | | comparison |
| 16 | 70 | 61.9 | 10 | 10 | 0.2 | | |
| 17 | 72 | 61.9 | 10 | 10 | 0.2 | | |
| 18 | 75 | 61.9 | 10 | 10 | 0.2 | | |
| 19 | 80 | 61.9 | 10 | 10 | 0.2 | | |
| 20 | 60 | 90.5 | 10 | 10 | 0.2 | Galling mark | |
| 21 | 60 | 61.9 | 10 | 10 | 0.2 | Aluminum | |
| 22 | 72 | 61.9 | 20 | 10 | 0.2 | ironing | |
| | | | | | | powder | |
| 23 | 72 | 61.9 | 0.5 | 10 | 0.2 | Galling mark | |

[symbol]

indicates data missing or illegible when filed

### Example 2

Coating was done with the viscosities shown in Table 2 under the conditions for Example 1 of the present invention shown in Table 1. The appearance in Table 2 was evaluated by the same method as in Example 1. Nos. 1 to 5 in Table 2 are examples for comparison in which the filler could moved in the paint with relative ease because the viscosity thereof was as low as under 20 centipoise. This impaired the parallelism of the filler in the coated film with respect to the surface of the metal strip and, therefore, caused somewhat great variations in the degree of glossiness.

Nos. 11 to 15 were also examples for comparison in which the viscosity of the paint exceeded 350 centipoise. While the thickness of coating applied by the coater tended to vary, the resulted unevenness was difficult to level off under gravity because of the high viscosity. As a consequence, the degree of glossiness varied rather extensively.

Nos. 6 to 6 were examples of the present invention in which the viscosity of the paint was between 20 centipoise and 350 centipoise. Therefore, poor appearances due to the movement of the filler and uneven coating were avoided. The viscosity was determined with the E-type viscometer after heating the paints to 20° C.

TABLE 2

| | | | Paint Parameters | | | | | |
|---|---|---|---|---|---|---|---|---|
| | Coating Conditions | | | | Dry | | | |
| | Roll | Linear | | | Weight | Paint | | |
| | Diameter | Pressure | | | Ratio | Viscosity | | |
| No | (mmφ) | (kg/cm) | Pigment | Resin | (%) | (cp) | Appearance | Remarks |
| 1 | 300 | 3 | Aluminum | Polyester | 20 | 1 | ◯ | Examples for |
| 2 | 300 | 3 | Aluminum | Polyester | 20 | 5 | ◯ | comparison |
| 3 | 300 | 3 | Aluminum | Polyester | 20 | 10 | ◯ | |
| 4 | 300 | 3 | Aluminum | Polyester | 20 | 15 | ◯ | |
| 5 | 300 | 3 | Aluminum | Polyester | 20 | 18 | ◯ | |
| 6 | 300 | 3 | Aluminum | Polyester | 20 | 20 | ⊚ | Examples of |
| 7 | 300 | 3 | Aluminum | Polyester | 20 | 50 | ⊚ | the present |
| 8 | 300 | 3 | Aluminum | Polyester | 20 | 100 | ⊚ | invention |
| 9 | 300 | 3 | Aluminum | Polyester | 20 | 300 | ⊚ | |
| 10 | 300 | 3 | Aluminum | Polyester | 20 | 350 | ⊚ | |
| 11 | 300 | 3 | Aluminum | Polyester | 20 | 360 | ◯ | Examples for |
| 12 | 300 | 3 | Aluminum | Polyester | 20 | 380 | ◯ | comparison |
| 13 | 300 | 3 | Aluminum | Polyester | 20 | 400 | ◯ | |
| 14 | 300 | 3 | Aluminum | Polyester | 20 | 420 | ◯ | |
| 15 | 300 | 3 | Aluminum | Polyester | 20 | 450 | ◯ | |

### INDUSTRIAL APPLICABILITY

The present invention dramatically improves the forming stability in heavy ironing of one-side coated steel sheets and, thus, provides metal strips with metallic-appearance excellent in forming stability, seamlessly-formed cans made of such steels, and methods for manufacturing such metal strips and cans.

As such, the present invention has great contributions to the development of can manufacturing and utilizing industries.

1-5. (canceled)

6. A method for manufacturing at least one metal strip with a metallic-appearance excellent in forming stability, comprising:
setting a ratio a/(a+b) at 20% to 45%, where a is a sum of the weights of a filler of at least one of aluminum or aluminum alloys and resin in a paint, and (a+b) is a sum of a and b of organic solvent for dissolving the paint, and
at least one of roll-coating or photogravure-coating at a linear pressure of at least approximately 3 kg/cm between the metal strip and rolls by using coating-rolls having a diameter of at most approximately 500 mmΦ.

7. A method of claim 6, wherein a statistic viscosity of the paint applied by roll-coating is approximately 20 to 350 centipoise at 20° C.

8-11. (canceled)

12. A method for manufacturing a seamlessly-formed can body, comprising:
applying multistage ironing to a metal strip with a thickness reduction ratio γ by using two or more dies such that a Total thickness reduction ratio γ<58+11d0.35 (wherein d is a thickness (μm) of the resin-rich portion containing at most approximately 5 mass % of filler in a coated surface at distance from a coated side),
wherein the metal strip has a single coated film layer on the side thereof corresponding to an external side of a can, the metal strip comprising:
a filler-rich portion containing not less than approximately 20 mass %, in the coated and dried state, of a filler of at least one of aluminum or aluminum alloys, and
a resin-rich portion containing not more than approximately 5 mass % of said filler and approximately 0.1 to 20 μm in thickness provided upon the filler-rich portion, and
wherein the filler-rich portion is dilutely distributed in the direction of thickness of the coated film layer.

13. A method of claim 12, wherein the ironing is performed by using a die whose intersection point between the entry and exit half angles has a radius of curvature not less than 0.02 mmΦ, and an entry half angle is set at 2° to 10°.

14. A method of claim 12, wherein the ironing is performed by using a die whose intersection point between the entry and exit half angles has a radius of curvature not less than 0.1 mmΦ, and an entry half angle set at 2° to 18°.

15. A method for manufacturing a seamlessly-formed can body, comprising:
applying multistage ironing to a metal strip with a thickness reduction ratio γ by using two or more dies such that a Total thickness reduction ratio γ<58+11d0.35 (wherein d is a thickness (μm) of the resin-rich portion containing at most approximately 5 mass % of filler in a coated surface at distance from a coated side),
wherein the metal strip has a single coated film layer on the side thereof corresponding to an external side of a can, the metal strip comprising:
a filler-rich portion containing not less than approximately 20 mass %, in the coated and dried state, of a filler of at least one of aluminum or aluminum alloys, and
a resin-rich portion containing not more than approximately 5 mass % of said filler and approximately 0.3 to 10 μm in thickness provided upon the filler-rich portion, and
wherein the filler-rich portion is dilutely distributed in the direction of thickness of the coated film layer.

16. A method of claim 12, wherein the ironing is performed by using a die whose intersection point between the entry and exit half angles has a radius of curvature not less than 0.02 mmΦ, and an entry half angle is set at 2° to 10°.

17. A method of claim 12, wherein the ironing is performed by using a die whose intersection point between the entry and exit half angles has a radius of curvature not less than 0.1 mmΦ, and an entry half angle set at 2° to 18°.
